(19) United States
(12) Patent Application Publication
(10) Pub. No.: US 2023/0229048 A1
(43) Pub. Date: Jul. 20, 2023

(54) OPTICAL ELEMENT AND THREE-DIMENSIONAL DISPLAY DEVICE

(71) Applicant: Sharp Display Technology Corporation, Kameyama City (JP)

(72) Inventors: Akira SAKAI, Kameyama City (JP); Masahiro HASEGAWA, Kameyama City (JP)

(21) Appl. No.: 18/096,485

(22) Filed: Jan. 12, 2023

(30) Foreign Application Priority Data
Jan. 17, 2022 (JP) 2022-004951

(51) Int. Cl. G02F 1/137; G02B 30/26

(52) U.S. Cl. CPC G02F 1/137; G02B 30/26; G02F 1/13363

(57) ABSTRACT

Provided is an optical element including: a first liquid crystal cell; and a second liquid crystal cell, with no polarizing plate between the first and second liquid crystal cells. The first liquid crystal cell includes a first liquid crystal layer containing first liquid crystal molecules, and a first electrode pair which applies voltage to the first liquid crystal layer. The second liquid crystal cell includes a second liquid crystal layer containing second liquid crystal molecules, and a second electrode pair which applies voltage to the second liquid crystal layer. With no voltage applied to the first and second liquid crystal layers, an alignment direction of the first liquid crystal molecules near the second liquid crystal cell in the first liquid crystal layer is parallel to an alignment direction of the second liquid crystal molecules near the first liquid crystal cell in the second liquid crystal layer in a plan view.

### CROSS-REFERENCE TO RELATED APPLICATIONS

The present application claims priority under 35 U.S.C. § 119 to Japanese Patent Application No. 2022-004951 filed on Jan. 17, 2022, the contents of which are incorporated herein by reference in their entirety.

### BACKGROUND OF THE INVENTION

### FIELD OF THE INVENTION

The following disclosure relates to optical elements and three-dimensional display devices including the optical elements.

### DESCRIPTION OF RELATED ART

Display devices represented by liquid crystal panels, for example, are often used together with an optical element for the purposes such as viewing angle compensation. For example, JP H04-37713 A discloses a liquid crystal display device including an image-displaying liquid crystal panel in which liquid crystals are sandwiched between transparent insulating substrates each including transparent electrodes; a compensating liquid crystal panel in which liquid crystals are sandwiched between transparent insulating substrates each including a whole surface transparent electrode; and polarizers whose absorption axes are perpendicular to each other and between which the panels are sandwiched.

JP 2012-18396 A discloses a stereoscopic image recognition apparatus including: a liquid crystal display device including a liquid crystal cell and a pair of polarizing plates on the respective sides of the liquid crystal cell; and a time division image display interception device including a polarizer, a liquid crystal encapsulation body, and a λ/4 plate B, wherein a λ/4 plate A is disposed on a visible side of the polarizer of the display side polarizing plate in the liquid crystal display device, and the liquid crystal encapsulation body and the λ/4 plate B are disposed on a liquid crystal display device side of the polarizer in the time division image display interception device.

### BRIEF SUMMARY OF THE INVENTION

A method of providing three-dimensional display has been suggested. The method includes, in a display device including a stack of two liquid crystal panels, alternately displaying an image intended for the left eye and an image intended for the right eye on a back surface side liquid crystal panel, controlling the polarizations of the images using a viewing surface side liquid crystal panel, and causing the images intended for the left eye and the images intended for the right eye to be separately perceived through polarizing glasses. The viewing surface side liquid crystal panel functions as what is called an active retarder. Such a display device that time-divisionally presents different images to the left and right eyes to create a sense of depth is also called an active retarder-type three-dimensional display device.

The active retarder-type three-dimensional display device causes what is called a crosstalk phenomenon where each eye sees a combination of an image intended for that eye and (some of) an image intended for the other eye, so that the sense of depth is lost.

Neither JP H04-37713 A nor JP 2012-18396 A discloses a technique for reducing crosstalk which occurs when the display device is observed from the normal direction.

In response to the above issues, an object of the present invention is to provide an optical element capable of reducing crosstalk in the normal direction when disposed on or over the viewing surface side of a display panel that alternately displays an image intended for the left eye (left eye image) and an image intended for the right eye (right eye image); and a three-dimensional display device including the optical element.

(1) One embodiment of the present invention is directed to an optical element including: a first liquid crystal cell; and a second liquid crystal cell disposed on or over the first liquid crystal cell, the optical element comprising no polarizing plate between the first liquid crystal cell and the second liquid crystal cell, the first liquid crystal cell including a first liquid crystal layer containing first liquid crystal molecules, and a first electrode pair which applies voltage to the first liquid crystal layer, the second liquid crystal cell including a second liquid crystal layer containing second liquid crystal molecules, and a second electrode pair which applies voltage to the second liquid crystal layer, with no voltage applied to the first liquid crystal layer and the second liquid crystal layer, an alignment direction of the first liquid crystal molecules near the second liquid crystal cell in the first liquid crystal layer is parallel to an alignment direction of the second liquid crystal molecules near the first liquid crystal cell in the second liquid crystal layer in a plan view.

(2) In an embodiment of the present invention, the optical element includes the structure (1) and, with no voltage applied to the first liquid crystal layer and the second liquid crystal layer, the alignment direction of the first liquid crystal molecules near the second liquid crystal cell in the first liquid crystal layer is parallel to the alignment direction of the second liquid crystal molecules near the first liquid crystal cell in the second liquid crystal layer in a cross-sectional view.

(3) In an embodiment of the present invention, the optical element includes the structure (1) or (2), and a thickness of the first liquid crystal layer is different from a thickness of the second liquid crystal layer.

(4) In an embodiment of the present invention, the optical element includes the structure (1), (2), or (3), and a thickness D1 as a thickness of the first liquid crystal layer or a thickness of the second liquid crystal layer satisfies the following formula (1):

0.80×D≤D1<0.98×D (Formula 1)

where D represents an average thickness of the thickness of the first liquid crystal layer and the thickness of the second liquid crystal layer.

(5) In an embodiment of the present invention, the optical element includes the structure (1), (2), (3), or (4), and a retardation of the first liquid crystal cell with no voltage applied to the first liquid crystal layer is different from a retardation of the second liquid crystal cell with no voltage applied to the second liquid crystal layer.

(6) Another embodiment of the present invention is directed to a three-dimensional display device including: the optical element including the structure (1), (2), (3), (4), or (5); and a display panel on or behind a back surface side of the optical element.

(7) In an embodiment of the present invention, the three-dimensional display device includes the structure (6) and a viewing angle compensation film.

The present invention can provide an optical element capable of reducing crosstalk in the normal direction when disposed on or over the viewing surface side of a display panel that alternately displays a left eye image and a right eye image; and a three-dimensional display device including the optical element.

### BRIEF DESCRIPTION OF THE DRAWINGS

FIG. 1 is a schematic cross-sectional view of an optical element of Embodiment 1.

FIG. 2 is an enlarged schematic cross-sectional view of the optical element of Embodiment 1.

FIG. 3 is an enlarged schematic plan view of the optical element of Embodiment 1.

FIG. 4 is a schematic view used to describe a conventional method of providing three-dimensional display.

FIG. 5 is a schematic cross-sectional view of a three-dimensional display device of Embodiment 2.

FIG. 6 is a schematic cross-sectional view of a three-dimensional display device of Comparative Example 1, Comparative Example 2, or Reference Example 1.

### DETAILED DESCRIPTION OF THE INVENTION

Hereinafter, embodiments of the present invention are described. The present invention is not limited to the contents of the following embodiments, and the design of the present invention can be modified as appropriate within the range satisfying the configuration of the present invention. Hereinafter, the same reference signs appropriately refer to the same portions or the portions having the same function throughout the drawings, and redundant description of already described portions is omitted as appropriate. The modes in the present invention may appropriately be combined within the gist of the present invention.

[Definition of terms]

The “viewing surface side” herein means the side closer to the screen (display surface) of the liquid crystal panel. The “back surface side” herein means the side farther from the screen (display surface) of the liquid crystal panel.

The “azimuth” herein means the direction in question in a view projected onto the screen of the display panel and is expressed as an angle (azimuthal angle) formed with the reference azimuth. The angle (azimuthal angle) measures positive in the counterclockwise direction and measures negative in the clockwise direction when the screen of the display panel is viewed from the viewing surface side (front). The angle (azimuthal angle) is a value measured in a plan view of the display panel.

The expression that two straight lines (including axes and directions) are “perpendicular” herein means that they are perpendicular in a plan view unless otherwise specified. The expression that two straight lines (including axes and directions) are “parallel” means that they are parallel in a plan view unless otherwise specified.

The expression that two axes (directions) are “perpendicular” herein means that they form an angle (absolute value) of 90°±3°, preferably 90°±1°, more preferably 90°±0.5°, particularly preferably 90° (perfectly perpendicular). The expression that two axes (directions) are “parallel” means that they form an angle (absolute value) of 0°±3°, preferably 0°±1°, more preferably 0°±0.5°, particularly preferably 0° (perfectly parallel).

The “axial azimuth” herein means, unless otherwise specified, the azimuth of the absorption axis of a polarizer or the slow axis of a liquid crystal layer.

The retardation Rp in the in-plane direction herein is defined by Rp=(ns−nf)d. The retardation Rth in the thickness direction is defined by Rth=(nz−(nx+ny)/2)d. In the formulas, ns represents nx or ny, whichever is greater, while of represents nx or ny, whichever is smaller; nx and ny each represent a principal refractive index in the in-plane direction of a birefringent layer (including a liquid crystal cell); nz represents a principal refractive index in the out-of-plane direction, i.e., the direction perpendicular to a surface of the birefringent layer; and d represents the thickness of the birefringent layer. The retardation in the in-plane direction is also referred to simply as the retardation herein.

The measurement wavelength for optical parameters such as a principal refractive index and a phase difference (retardation) herein is 550 nm unless otherwise specified.

The “birefringent layer” herein means a layer having optical anisotropy and is a concept encompassing liquid crystal cells. The birefringent layer provides, for example, a retardation in the in-plane direction or a retardation in the thickness direction in absolute value of not less than 10 nm, preferably not less than 20 nm.

Hereinafter, embodiments of the present invention are described. The present invention is not limited to the contents of the following embodiments. The design may be modified as appropriate within the range satisfying the configuration of the present invention.

### Embodiment 1

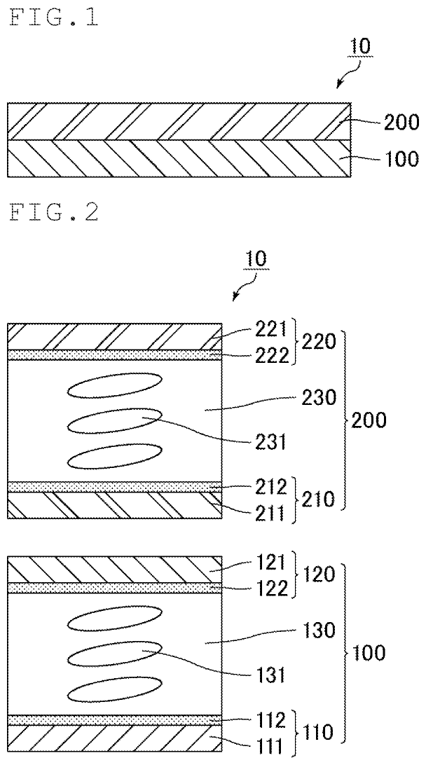

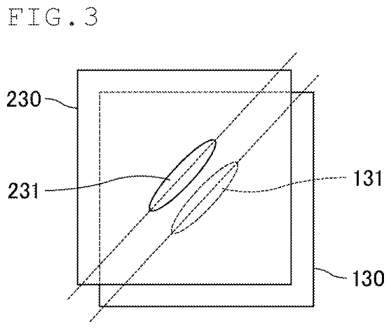

FIG. 1 is a schematic cross-sectional view of an optical element of Embodiment 1. FIG. 2 is an enlarged schematic cross-sectional view of the optical element of Embodiment 1. FIG. 3 is an enlarged schematic plan view of the optical element of Embodiment 1. FIG. 3 is a schematic plan view of FIG. 2. FIG. 1 to FIG. 3 show that an optical element 10 of the present embodiment includes a first liquid crystal cell 100 and a second liquid crystal cell 200 disposed on or over the first liquid crystal cell 100, with no polarizing plate between the first liquid crystal cell 100 and the second liquid crystal cell 200. The first liquid crystal cell 100 includes a first liquid crystal layer 130 containing first liquid crystal molecules 131, and a first electrode pair which consists of a first electrode 112 and a second electrode 122 and applies voltage to the first liquid crystal layer 130. The second liquid crystal cell 200 includes a second liquid crystal layer 230 containing second liquid crystal molecules 231, and a second electrode pair which consists of a third electrode 212 and a fourth electrode 222 and applies voltage to the second liquid crystal layer 230. With no voltage applied to the first liquid crystal layer 130 and the second liquid crystal layer 230, the alignment direction of the first liquid crystal molecules 131 near the second liquid crystal cell 200 in the first liquid crystal layer 130 is parallel to the alignment direction of the second liquid crystal molecules 231 near the first liquid crystal cell 100 in the second liquid crystal layer 230 in a plan view.

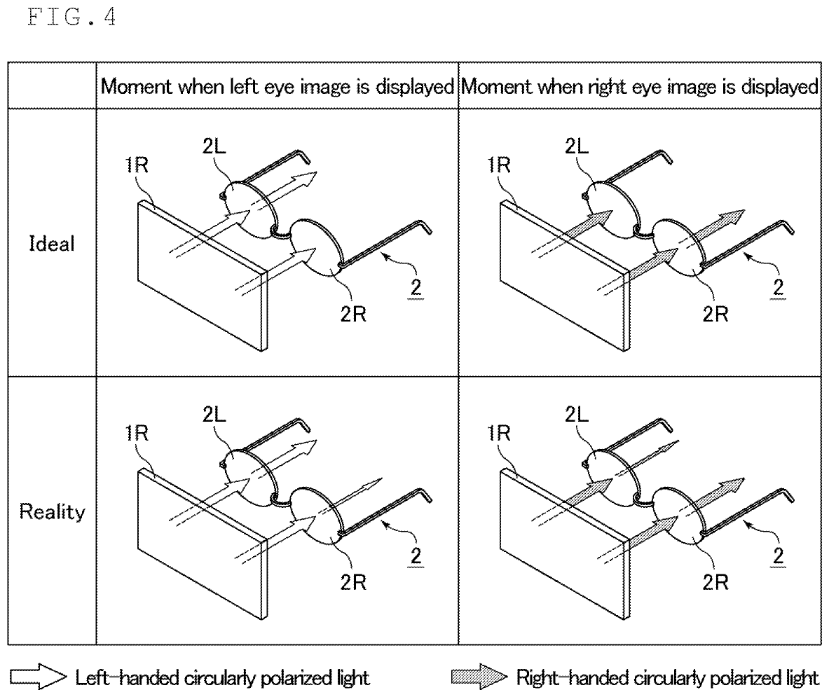

A conventional three-dimensional (3D) display method is now described. FIG. 4 is a schematic view used to describe a conventional method of providing three-dimensional display. As shown in FIG. 4, a conventional three-dimensional display method uses a three-dimensional display device 1R including two liquid crystal panels, and polarizing glasses 2. Each of the liquid crystal panels applies voltage to the liquid crystal layer sealed between paired substrates to change the alignment of the liquid crystal molecules in the liquid crystal layer according to the applied voltage, thereby controlling the amount of light transmitted.

Specifically, the three-dimensional display device 1R alternately displays a left eye image and a right eye image on the back surface side liquid crystal panel and utilizes the viewing surface side liquid crystal panel (active retarder) to control the polarization state of light for each image. Each eye perceives light emitted from the three-dimensional display device 1R for an image intended for that eye through the polarizing glasses 2, so that the user feels a sense of depth in the image.

In order for the conventional three-dimensional display device 1R to completely separate left and right eye images, the retardation introduced by the active retarder needs to be exactly the same as the designed retardation. These retardations, however, inevitably deviate from each other with a certain probability industrially due to the influence of variations in manufacturing. For example, when a retardation of 275 nm is to be introduced by a liquid crystal layer having a thickness (cell thickness) of 3.0 μm, a thickness variation of ±0.2 μm of the liquid crystal layer results in a retardation variation of ±18 nm.

As shown in FIG. 4, ideally, left-handed circularly polarized light passes only through the left lens 2L of the polarizing glasses 2 at the moment when the left eye image is displayed while right-handed circularly polarized light passes only through the right lens 2R of the polarizing glasses 2 at the moment when the right eye image is displayed. However, in reality, the retardation variation due to the cell thickness variation of the active retarder causes light to pass also through the right lens 2R at the moment when the left eye image is displayed while causing light to pass also through the left lens 2L at the moment when the right eye image is displayed. This phenomenon was found to cause crosstalk (light leakage). The present inventors found that the conventional configuration of the active retarder defined by one liquid crystal cell whose cell thickness is set to a design center value of d produces a variation in cell thickness, ultimately causing crosstalk.

The optical element 10 of the present embodiment includes the first liquid crystal cell 100 and the second liquid crystal cell 200 disposed on or over the first liquid crystal cell 100, with no polarizing plate between the first liquid crystal cell 100 and the second liquid crystal cell 200. The first liquid crystal cell 100 includes the first liquid crystal layer 130 containing the first liquid crystal molecules 131, and the first electrode pair which consists of the first electrode 112 and the second electrode 122 and applies voltage to the first liquid crystal layer 130. The second liquid crystal cell 200 includes the second liquid crystal layer 230 containing the second liquid crystal molecules 231, and the second electrode pair which consists of the third electrode 212 and the fourth electrode 222 and applies voltage to the second liquid crystal layer 230. With no voltage applied to the first liquid crystal layer 130 and the second liquid crystal layer 230, the alignment direction of the first liquid crystal molecules 131 near the second liquid crystal cell 200 in the first liquid crystal layer 130 is parallel to the alignment direction of the second liquid crystal molecules 231 near the first liquid crystal cell 100 in the second liquid crystal layer 230 in a plan view. This configuration enables two liquid crystal cells (the first liquid crystal cell 100 and the second liquid crystal cell 200) whose cell thickness is set to a design center value of d/2 to be stacked to define an optical element with a cell thickness design center value of d. When an optical element is defined by one liquid crystal cell, a cell thickness variation of the one liquid crystal cell from the design center value directly causes deterioration of the optical properties of the optical element. In contrast, in the optical element 10 of the present embodiment defined by two liquid crystal cells (the first liquid crystal cell 100 and the second liquid crystal cell 200), a cell thickness variation of one of the two liquid crystal cells from the design center value can absorb a cell thickness variation of the other liquid crystal cell from the design center value. This configuration enables reduction of cell thickness variations of the whole optical element 10, thus enabling reduction of crosstalk in the normal direction when the optical element 10 is disposed on or over the viewing surface side of the display panel that alternately displays a left eye image and a right eye image.

As described above, the optical element 10 of the present embodiment, when disposed on or over the viewing surface side of a display panel that alternately displays a left eye image and a right eye image, controls the polarization state of each image to enable display of a three-dimensional image. In other words, the optical element 10 is an optical element for a three-dimensional display device.

The alignment direction of the first liquid crystal molecules 131 near the second liquid crystal cell 200 in the first liquid crystal layer 130 more specifically means the alignment direction of the first liquid crystal molecules 131 in the interface of the first liquid crystal layer 130 closer to the second liquid crystal cell 200. Similarly, the alignment direction of the second liquid crystal molecules 231 near the first liquid crystal cell 100 in the second liquid crystal layer 230 more specifically means the alignment direction of the second liquid crystal molecules 231 in the interface of the second liquid crystal layer 230 closer to the first liquid crystal cell 100.

JP H04-37713 A discloses a liquid crystal display device including a stack of two liquid crystal panels (a display-providing liquid crystal panel and a compensating liquid crystal panel). The liquid crystal display device disclosed in JP H04-37713 A has a what is called a double super-twisted nematic (STN) liquid crystal structure in which the panels compensate for each other's retardation. The structure is limited to one in which the long axis directions of the liquid crystal molecules closest between the two liquid crystal panels are perpendicular to each other in a plan view. This document neither discloses nor suggests a method of reducing crosstalk which is caused by a cell thickness variation and which is an issue in observation from the normal direction.

In contrast, in the optical element 10 of the present embodiment with no voltage applied to the first liquid crystal layer 130 and the second liquid crystal layer 230, the alignment direction of the first liquid crystal molecules 131 near the second liquid crystal cell 200 in the first liquid crystal layer 130 is parallel to the alignment direction of the second liquid crystal molecules 231 near the first liquid crystal cell 100 in the second liquid crystal layer 230 in a plan view. Specifically, the long axis directions of the liquid crystal molecules closest between the two liquid crystal panels are parallel to each other in a plan view, which form a different structure different from the optical element in JP H04-37713 A. The optical element 10 of the present embodiment also can reduce crosstalk which is due to a cell thickness variation and is an issue in observation from the normal direction.

JP 2012-18396 A discloses a method of reducing crosstalk, which is an issue in observation from an oblique direction in an active retarder-type three-dimensional display device, using an optically anisotropic layer. However, this document neither discloses nor suggests a method of reducing crosstalk which is caused by a cell thickness variation of the liquid crystal cell (liquid crystal encapsulation body) and is an issue in observation from the normal direction. Hereinafter, the present embodiment is described in detail.

As shown in FIG. 1 to FIG. 3, the first liquid crystal cell 100 in the optical element 10 of the present embodiment includes the first substrate 110, the second substrate 120 facing the first substrate 110, and the first liquid crystal layer 130 sandwiched between the first substrate 110 and the second substrate 120. The second liquid crystal cell 200 includes the third substrate 210, the fourth substrate 220 facing the third substrate 210, and the second liquid crystal layer 230 sandwiched between the third substrate 210 and the fourth substrate 220. The second liquid crystal cell 200 is disposed on or over the first liquid crystal cell 100 in a cross-sectional view. That is, the second liquid crystal cell 200 is facing the first liquid crystal cell 100.

The first liquid crystal cell 100 and the second liquid crystal cell 200 both are passive liquid crystal cells which are passively driven. The first substrate 110 in the first liquid crystal cell 100 includes a first supporting substrate 111 and a first electrode 112 which is a solid electrode covering the entire screen. The second substrate 120 includes a second supporting substrate 121 and a second electrode 122 which is a solid electrode covering the entire screen. This configuration enables the alignment of the first liquid crystal molecules 131 in the first liquid crystal layer 130 to vary according to the voltage applied between the first electrode 112 and the second electrode 122 defining the electrode pair which applies voltage to the first liquid crystal layer 130, thus enabling control of the retardation introduced by the first liquid crystal cell 100.

Similarly, the third substrate 210 in the second liquid crystal cell 200 includes a third supporting substrate 211 and a third electrode 212 which is a solid electrode covering the entire screen. The fourth substrate 220 includes a fourth supporting substrate 221 and a fourth electrode 222 which is a solid electrode covering the entire screen. This configuration enables the alignment of the second liquid crystal molecules 231 in the second liquid crystal layer 230 to vary according to the voltage applied between the third electrode 212 and the fourth electrode 222 defining an electrode pair which applies voltage to the second liquid crystal layer 230, thus enabling control of the retardation introduced by the second liquid crystal cell 200.

The present embodiment relates to a case where the first liquid crystal cell 100 and the second liquid crystal cell 200 are passive liquid crystal cells. The driving method of the first liquid crystal cell 100 and the second liquid crystal cell 200 is not limited thereto. The first liquid crystal cell 100 and the second liquid crystal cell 200 may be active matrix liquid crystal cells driven by an active matrix driving method, for example. In this case, as with a typical active matrix liquid crystal cell, the first liquid crystal cell 100 and the second liquid crystal cell 200 each include parallel gate lines; parallel source lines that intersect the gate lines with an insulating film in between; thin film transistors (TFTs) as switching elements at the respective intersections of the source lines and the gate lines; and pixel electrodes disposed in the respective pixels and connected to the respective TFTs.

The active matrix liquid crystal cell may be driven by any method. For example, a commonly used active matrix driving method may be used. In other words, the TFTs disposed in the respective pixels are switched on or off (turned on or off) via a gate driver. The switching is followed by application of voltage to the switched-on pixel via the source driver so as to store electric charge in the storage capacitor in the pixel via the drain bus of the corresponding TFT. The storage capacitor maintains the pixel turned on.

The first liquid crystal cell 100 and the second liquid crystal cell 200 are preferably passive liquid crystal cells. An active matrix liquid crystal cell requires fabrication of elements for active matrix driving therein, whereas a passive liquid crystal cell does not require fabrication of such elements therein. Thus, with the first liquid crystal cell 100 and the second liquid crystal cell 200 being passive liquid crystal cells, the transmittance can be increased and the production cost can be reduced.

Herein, the state with voltage applied to the liquid crystal layer means a state where a voltage equal to or higher than the threshold is applied to the electrode pair which applies voltage to the liquid crystal layer, and this state is also referred to simply as “with voltage applied”. Also, the state with no voltage applied to the liquid crystal layer means a state where voltage lower than the threshold is applied to the electrode pair which applies voltage to the liquid crystal layer (including no voltage application), and this state is also referred to simply as “with no voltage applied”.

Examples of the first supporting substrate 111, the second supporting substrate 121, the third supporting substrate 211, and the fourth supporting substrate 221 include insulating substrates such as glass substrates and plastic substrates. Examples of the material for the glass substrates include glass such as float glass and soda-lime glass. Examples of the material for the plastic substrates include plastics such as polyethylene terephthalate, polybutylene terephthalate, polyethersulfone, polycarbonate, and alicyclic polyolefin.

The first electrode 112, the second electrode 122, the third electrode 212, and the fourth electrode 222 are preferably transparent electrodes. The first electrode 112, the second electrode 122, the third electrode 212, and the fourth electrode 222 can each be formed by forming a single- or multi-layered film of a transparent conductive material such as indium tin oxide (ITO), indium zinc oxide (IZO), zinc oxide (ZnO), or tin oxide (SnO) or an alloy of any of these materials by a method such as sputtering, followed by patterning of the film by a method such as photolithography.

The first liquid crystal layer 130 and the second liquid crystal layer 230 (hereinafter, also referred to simply as the liquid crystal layers) each contain a liquid crystal material and control the amount of light passing therethrough by varying the alignment of the liquid crystal molecules in the liquid crystal material according to the voltage applied to the liquid crystal layer.

The anisotropy of dielectric constant (Δε) of the liquid crystal molecules is defined by the following formula (L). The liquid crystal molecules may have a positive or negative anisotropy of dielectric constant. Liquid crystal molecules having a positive anisotropy of dielectric constant are also referred to as positive liquid crystal molecules, while liquid crystal molecules having a negative anisotropy of dielectric constant are also referred to as negative liquid crystal molecules. The direction of the long axes of liquid crystal molecules corresponds to the direction of the slow axis. The direction of the long axes of liquid crystal molecules with no voltage applied is also referred to as the initial alignment direction of the liquid crystal molecules.

Δε=(dielectric constant in long axis direction of liquid crystal molecules)−(dielectric constant in short axis direction of liquid crystal molecules) (L)

The first liquid crystal cell may include at least one of an alignment film between the first substrate 110 and the first liquid crystal layer 130 or an alignment film between the second substrate 120 and the first liquid crystal layer 130. The second liquid crystal cell may include at least one of an alignment film between the third substrate 210 and the second liquid crystal layer 230 or an alignment film between the fourth substrate 220 and the second liquid crystal layer 230. The alignment film has a function of controlling the alignment of liquid crystal molecules in a liquid crystal layer. When the voltage applied to the liquid crystal layer is lower than the threshold voltage (including the case of no voltage application), the alignment of the liquid crystal molecules in the liquid crystal layer is mainly controlled by the alignment films.

When the alignment direction of the liquid crystal molecules with no voltage applied depends on the type of the alignment film and the alignment films on both substrates defining the liquid crystal cell are horizontal alignment films, the liquid crystal molecules with no voltage applied align homogeneously. When the alignment films on both substrates defining the liquid crystal cell are vertical alignment films, the liquid crystal molecules with no voltage applied align homeotropically. When one of the alignment films on both substrates defining the liquid crystal cell is a horizontal alignment film and the other is a vertical alignment film, the alignment direction of the liquid crystal molecules with no voltage applied gradually varies relative to the thickness direction of the liquid crystal layer (hybrid alignment).

With no voltage applied to the first liquid crystal layer 130 and the second liquid crystal layer 230, the alignment direction of the first liquid crystal molecules 131 near the second liquid crystal cell 200 in the first liquid crystal layer 130 is preferably parallel to the alignment direction of the second liquid crystal molecules 231 near the first liquid crystal cell 100 in the second liquid crystal layer 230 in a cross-sectional view. This configuration can cause the alignment of the first liquid crystal molecules 131 in the first liquid crystal layer 130 and the alignment of the second liquid crystal molecules 231 in the second liquid crystal layer 230 to be more alike, thus achieving a state optically equal to the state with a single liquid crystal cell without the second supporting substrate 121 and the third supporting substrate 211. This ultimately enables more effective reduction of crosstalk in the normal direction.

With the same voltage applied to the first liquid crystal layer 130 and the second liquid crystal layer 230, the alignment direction of the first liquid crystal molecules 131 near the second liquid crystal cell 200 in the first liquid crystal layer 130 is preferably parallel to the alignment direction of the second liquid crystal molecules 231 near the first liquid crystal cell 100 in the second liquid crystal layer 230 in a plan view, more preferably parallel to the alignment direction of the second liquid crystal molecules 231 near the first liquid crystal cell 100 in the second liquid crystal layer 230 in a plan view and a cross-section view. This configuration enables more effective reduction of crosstalk in the normal direction.

With no voltage applied to the first liquid crystal layer 130 and the second liquid crystal layer 230, the slow axis of the first liquid crystal layer 130 is preferably parallel to the slow axis of the second liquid crystal layer 230 in a plan view. This configuration allows the two liquid crystal cells (the first liquid crystal cell 100 and the second liquid crystal cell 200) to be considered as substantially one liquid crystal cell. This ultimately enables further reduction of crosstalk in the normal direction.

With the same voltage applied to the first liquid crystal layer 130 and the second liquid crystal layer 230, the slow axis of the first liquid crystal layer 130 is preferably parallel to the slow axis of the second liquid crystal layer 230 in a plan view. This configuration allows the two liquid crystal cells (the first liquid crystal cell 100 and the second liquid crystal cell 200) to be considered as substantially one liquid crystal cell. This ultimately enables further reduction of crosstalk in the normal direction.

A cell thickness variation is generated in production of the first liquid crystal cell 100 and second liquid crystal cell 200 as in conventional production. Such a cell thickness variation can be absorbed in the optical element 10 by measuring the thickness of each cell and combining a cell with a thickness greater than the design center value and a cell with a thickness smaller than the design center value. In other words, the thickness of the first liquid crystal layer 130 is preferably different from the thickness of the second liquid crystal layer 230. The optical element 10 with this configuration can absorb the cell thickness variation, further reducing crosstalk in the normal direction. The expression that the thicknesses of the two liquid crystal layers are different means that the difference in thickness between the two liquid crystal layers is 0.05 μm or more.

The measurement of the cell thickness is one of non-destructive tests and is common in the manufacturing process of liquid crystal panels in practice. Use of the first liquid crystal cell 100 and the second liquid crystal cell 200 with different cell thicknesses is therefore applicable to mass production as well.

The thickness D1 as the thickness of the first liquid crystal layer 130 or the thickness of the second liquid crystal layer 230 preferably satisfies the following formula (1):

0.80×D≤D1<0.98×D (Formula 1)

where D represents the average thickness of the thickness of the first liquid crystal layer 130 and the thickness of the second liquid crystal layer 230. This configuration enables more effective reduction of crosstalk in the normal direction.

The retardation introduced by the first liquid crystal cell 100 with no voltage applied to the first liquid crystal layer 130 is preferably different from the retardation introduced by the second liquid crystal cell 200 with no voltage applied to the second liquid crystal layer 230. The optical element 10 with this configuration can absorb the retardation variation due to the cell thickness variation to further reduce crosstalk in the normal direction. Here, the expression the retardations introduced by the two liquid crystal cells are different means that the difference in retardation between the two liquid crystal cells is 5 nm or more.

A retardation RLC1 as the retardation introduced by the first liquid crystal cell 100 with no voltage applied to the first liquid crystal layer 130 or the retardation introduced by the second liquid crystal cell 200 with no voltage applied to the second liquid crystal layer 230 preferably satisfies the following formula (2):

0.80×RLC≤RLC1<0.98×RLC (Formula 2)

where RLC represents the average retardation of the retardation introduced by the first liquid crystal cell 100 with no voltage applied to the first liquid crystal layer 130 and the retardation introduced by the second liquid crystal cell 200 with no voltage applied to the second liquid crystal layer 230. This configuration enables more effective reduction of crosstalk in the normal direction.

The retardation and cell thickness of a liquid crystal cell can be determined with an ellipsometer (cell thickness measurement device).

The optical element 10 includes no polarizing plate between the first liquid crystal cell 100 and the second liquid crystal cell 200. In this configuration, the two liquid crystal cells (the first liquid crystal cell 100 and the second liquid crystal cell 200) can be considered as substantially one liquid crystal cell.

The optical element 10 may include an air layer or a pressure-sensitive adhesive layer between the first liquid crystal cell 100 and the second liquid crystal cell 200. Also in this configuration, the two liquid crystal cells (the first liquid crystal cell 100 and the second liquid crystal cell 200) can be considered as substantially one liquid crystal cell. The configuration thus enables reduction of crosstalk in the normal direction.

A pressure-sensitive adhesive layer is a layer that bonds a surface of a component to a surface of an adjacent component to integrate the components with each other with a practically sufficient adhesion in a practically sufficient time. The pressure-sensitive adhesive layer itself exhibits viscous and elastic properties and forms a bond when slight pressure is applied to bond the adhesive with the surface at ordinary temperature for a short time, not though a chemical reaction triggered by water, solvent, or heat. Also, the pressure-sensitive adhesive layer is removable whereas a structural adhesive layer is not removable once it forms a bond. Such a pressure-sensitive adhesive layer can be formed from, for example, a resin material such as acrylic resin, silicon-based resin, or urethane-based resin, or a rubber material.

### Embodiment 2

The features unique to the present embodiment are mainly described in the present embodiment, and description of the same features as in Embodiment 1 is omitted. In the present embodiment, a display device including the optical element 10 of Embodiment 1 is described.

FIG. 5 is a schematic cross-sectional view of a three-dimensional display device of Embodiment 2. A three-dimensional display device 1 as the display device of the present embodiment, as shown in FIG. 5, includes the optical element 10 of Embodiment 1 and a liquid crystal display panel 20 as the display panel on or behind the back surface side of the optical element 10. This configuration allows the user to see an image displayed on the liquid crystal display panel 20 stereoscopically through the optical element 10.

The display panel preferably alternately displays a left eye image and a right eye image. This configuration enables more effective display of a three-dimensional image.

The optical element 10 can switch between a state where light used to display an image on the display panel is converted to right-handed circularly polarized light and a state where light used to display an image on the display panel is converted to left-handed circularly polarized light by switching between a state where no voltage is applied to the first liquid crystal layer 130 and the second liquid crystal layer 230 and a state where voltage is applied to the first liquid crystal layer 130 and the second liquid crystal layer 230. For example, in a state where no voltage is applied to the first liquid crystal layer 130 and the second liquid crystal layer 230, light used to display an image on the display panel can be converted to right-handed circularly polarized light. Meanwhile, in a state where voltage is applied to the first liquid crystal layer 130 and the second liquid crystal layer 230, light used to display an image on the display panel can be converted to left-handed circularly polarized light. The voltages applied to the first liquid crystal layer 130 and the second liquid crystal layer 230 may be the same as or different from each other.

The optical element 10 sequentially includes, from the back surface side toward the viewing surface side, the first liquid crystal cell 100 and the second liquid crystal cell 200. The liquid crystal display panel 20 sequentially includes, from the back surface side toward the viewing surface side, a first polarizing plate 1P, an image-displaying liquid crystal cell 400, and a second polarizing plate 2P.

Examples of the image-displaying liquid crystal cell 400 include one including a liquid crystal layer between paired substrates one of which includes pixel electrodes and a common electrode, and providing display by applying voltage between the pixel electrodes and the common electrode to generate a horizontal electric field (including a fringe electric field) in the liquid crystal layer; and one including a liquid crystal layer between paired substrates one of which includes pixel electrodes and the other of which includes a common electrode, and providing display by applying voltage between the pixel electrodes and the common electrode to generate a vertical electric field in the liquid crystal layer. Examples of the horizontal electric field mode include the fringe field switching (FFS) mode and the in plane switching (IPS) mode in which liquid crystal molecules in the liquid crystal layer with no voltage applied align parallel to the substrate surfaces. Example of the vertical electric field mode include the vertical alignment (VA) mode in which liquid crystal molecules in the liquid crystal layer with no voltage applied align vertical to the substrate surfaces.

The image-displaying liquid crystal cell 400 is a liquid crystal cell driven by the active matrix driving method. The image-displaying liquid crystal cell 400 includes a TFT substrate with thin film transistors, a counter substrate facing the TFT substrate, and an image-displaying liquid crystal layer sandwiched between the TFT substrate and the counter substrate.

The TFT substrate includes gate lines and source lines parallel to the gate lines arranged in a grid pattern, and TFTs as switching elements arranged at or near the intersections. Each region surrounded by the gate lines and the source lines defines a pixel. Each pixel includes a pixel electrode connected to the corresponding TFT 115. The counter substrate includes, for example, a common electrode which is a solid electrode covering the entire screen.

The image-displaying liquid crystal cell 400 may be driven by any method such as the active matrix driving method commonly employed. In other words, the TFTs in the respective pixels are switched on or off (turned on or off) via a gate driver. The switching is followed by application of voltage to the switched-on pixel via the source driver so as to store electric charge in the storage capacitor in the pixel via the drain bus of the corresponding TFT. The storage capacitor maintains the pixel turned on.

Preferably, the first polarizing plate 1P and the second polarizing plate 2P are both absorptive polarizing plates and arranged in crossed Nicols where the absorption axes thereof are perpendicular to each other. The first polarizing plate 1P and the second polarizing plate 2P can each be, for example, a polarizing plate (absorptive polarizing plate) obtained by dyeing a polyvinyl alcohol (PVA) film with an anisotropic material such as an iodine complex (or dye) to adsorb the anisotropic material on the PVA film, and stretching the film for alignment. Typically, in order to achieve a mechanical strength and moist heat resistance, each surface of the PVA film is laminated with a protective film such as a cellulose triacetate film for practical use. Herein, the “polarizing plate” refers to a linearly polarizing plate (absorptive polarizing plate) and is distinguished from circularly polarizing plates.

In the case of setting the absorption axis of the polarizing plate (second polarizing plate 2P) closer to the optical element 10 in the liquid crystal display panel 20 to the reference azimuth(0°), preferably, the absorption axis of the first polarizing plate 1P is at an azimuthal angle of 87° or greater and 93° or smaller, the slow axis of the first liquid crystal layer 130 in the first liquid crystal cell 100 with no voltage applied is at an azimuthal angle of 42° or greater and 48° or smaller, and the slow axis of the second liquid crystal layer 230 in the second liquid crystal cell 200 with no voltage applied is at an azimuthal angle of 42° or greater and 48° or smaller. This configuration enables effective reduction of crosstalk in the normal direction.

In addition, the azimuth of the slow axis of the first liquid crystal layer 130 with no voltage applied is more preferably parallel to the azimuth of the slow axis of the second liquid crystal layer 230 with no voltage applied. This configuration enables more effective reduction of crosstalk in the normal direction.

Preferably, the three-dimensional display device 1 further includes a viewing angle compensation film 410. Occurrence of crosstalk in the conventional three-dimensional display method is due to the cell thickness variation of the three-dimensional display device 1R as well as the poor viewing angle of the liquid crystal panel functioning as the active retarder. Typically, the viewing angle characteristics can be improved by adding a viewing angle compensation film. However, the effect which should be achieved by such addition may not be achieved when there is a cell thickness variation of the liquid crystal panel. When the influence of this cell thickness variation is reduced by the present embodiment, the effect of the viewing angle compensation film can always be achieved.

The viewing angle compensation film 410, for example, as shown in FIG. 5, is disposed on the surface of the first liquid crystal cell 100 not facing the second liquid crystal cell 200. The viewing angle compensation film 410 may be disposed on the surface of the second liquid crystal cell 200 not facing the first liquid crystal cell 100. Two viewing angle compensation films 410 may be disposed, one on the surface of the first liquid crystal cell 100 not facing the second liquid crystal cell 200 and the other on the surface of the second liquid crystal cell 200 not facing the first liquid crystal cell 100.

The viewing angle compensation film 410 is a phase difference film for optical compensation, and may be a film formed from a liquid crystalline polymer or a film obtained by subjecting a commercially available film to secondary processing such as stretching and/or shrinking. Examples of a polymer film formed from a commercially available cellulose-based resin include “FUJITAC” available from FUJIFILM Corporation and “KC8UX2M” available from KONICA MINOLTA OPTO, INC. Examples of a polymer film formed from a norbornene-based resin include “ZeonorFilm” available from Zeon Corporation and “ARTON” available from JSR Corporation.

### EXAMPLES

The effect of the present invention is described based on the following examples and comparative examples. The present invention is not limited to these examples.

### Examples 1 to 3

Three-dimensional display devices of Examples 1 to 3 having the same configuration as in Embodiment 2 were produced. The absorption axis of the first polarizing plate 1P was set at an azimuthal angle of 90°, the absorption axis of the second polarizing plate 2P was set at an azimuthal angle of 0°, the slow axis of the first liquid crystal layer 130 of the first liquid crystal cell 100 with no voltage applied was set at an azimuthal angle of 45°, and the slow axis of the second liquid crystal layer 230 of the second liquid crystal cell 200 with no voltage applied was set at an azimuthal angle of 45°. The thickness of the first liquid crystal layer 130 and the thickness and retardation of the second liquid crystal layer 230 were set as shown in the following Table 1.

TABLE 1

| | | Comparative | | Reference | | Comparative | | | | | | | |
|---|---|---|---|---|---|---|---|---|---|---|---|---|---|
| | | Example 1 | | Example 1 | | Example 2 | | Example 1 | | Example 2 | | Example 3 | |
| Thickness (cell | Thickness of third | 2.9 | μm | 3.0 | μm | 3.1 | μm | | | | | | |
| thickness) of | liquid crystal layer | | | | | | | | | | | | |
| liquid crystal | of third liquid | | | | | | | | | | | | |
| layer | crystal cell | | | | | | | | | | | | |
| | Thickness of second | | | | | | | 1.3 | μm | 1.5 | μm | 1.7 | μm |
| | liquid crystal layer | | | | | | | | | | | | |
| | of second liquid | | | | | | | | | | | | |
| | crystal cell | | | | | | | | | | | | |
| | Thickness of first | | | | | | | 1.7 | μm | 1.5 | μm | 1.3 | μm |
| | liquid crystal layer | | | | | | | | | | | | |
| | of first liquid | | | | | | | | | | | | |
| | crystal cell | | | | | | | | | | | | |
| | Total | 2.8 | μm | 3.0 | μm | 3.2 | μm | 3.0 | μm | 3.0 | μm | 3.0 | μm |
| Retardation | Total | 257 | nm | 275 | nm | 293 | nm | 275 | nm | 275 | nm | 275 | nm |
| | Variation | −18 | nm | 0 | nm | 18 | nm | 0 | nm | 0 | nm | 0 | nm |

| | | | | | | |
|---|---|---|---|---|---|---|
| Light leakage | 0.4128% | 0.0015% | 0.4128% | 0.0015% | 0.0015% | 0.0015% |

### Comparative Example 1, Comparative Example 2, and Reference Example 1

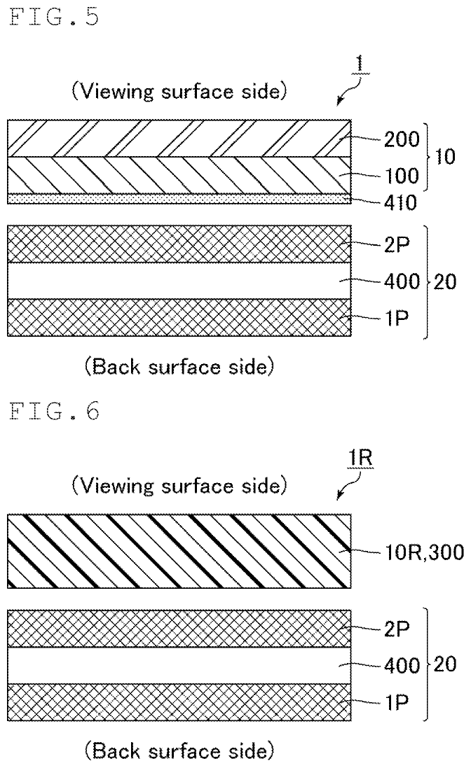

FIG. 6 is a schematic cross-sectional view of a three-dimensional display device of Comparative Example 1, Comparative Example 2, or Reference Example 1. The three-dimensional display devices 1R of Comparative Example 1, Comparative Example 2, and Reference Example 1 shown in FIG. 6 were produced. The three-dimensional display devices 1R of Comparative Example 1, Comparative Example 2, and Reference Example 1 had the same configuration as in Examples 1 to 3, except that an optical element 10R including one liquid crystal cell (third liquid crystal cell 300 including a third liquid crystal layer) was used instead of the optical element 10 including the two liquid crystal cells (the first liquid crystal cell 100 and the second liquid crystal cell 200).

The absorption axis of the first polarizing plate 1P was set at an azimuthal angle of 90°, the absorption axis of the second polarizing plate 2P was set at an azimuthal angle of 0°, and the slow axis of the third liquid crystal layer of the third liquid crystal cell 300 with no voltage applied was set at an azimuthal angle of 45°. The cell thickness and retardation of the third liquid crystal cell 300 in the three-dimensional display device 1R of each of Comparative Example 1, Comparative Example 2, and Reference Example 1 were set as shown in Table 1.

Reference Example 1 corresponds to a case where the final cell thickness of the third liquid crystal cell 300 in the conventional configuration was as designed. Comparative Example 1 corresponds to a case where the final cell thickness was smaller than the design center value. Comparative Example 2 corresponds to a case where the final cell thickness was greater than the design center value. The optical elements 10R of Comparative Example 1 and Comparative Example 2 caused larger light leakage (i.e., crosstalk) and had poorer three-dimensional display quality than that of Reference Example 1.

Example 2 corresponds to a case where the final cell thicknesses of both the first liquid crystal cell 100 and the second liquid crystal cell 200 were as designed. Example 1 and Example 3 each correspond to cases where a liquid crystal cell whose final cell thickness was smaller than the design center value and a liquid crystal cell whose final cell thickness was greater than the design center value were used in combination as the first liquid crystal cell 100 and the second liquid crystal cell 200. Each of the examples demonstrated small light leakage (crosstalk) and thus achieved a good three-dimensional display quality. The configurations of the examples were therefore confirmed to successfully reduce the influence of a possible cell thickness variation in manufacturing.

### REFERENCE SIGNS LIST

1, 1R: three-dimensional display device
1P, 2P: polarizing plate
2: polarizing glasses
2L, 2R: lens
10, 10R: optical element
20: liquid crystal display panel
100, 200, 300, 400: liquid crystal cell
110, 120, 210, 220: substrate
111, 121, 211, 221: supporting substrate
112, 122, 212, 222: electrode
130, 230: liquid crystal layer
131, 231: liquid crystal molecule
410: viewing angle compensation film

What is claimed is:

1. An optical element comprising:
a first liquid crystal cell; and
a second liquid crystal cell disposed on or over the first liquid crystal cell,
the optical element comprising no polarizing plate between the first liquid crystal cell and the second liquid crystal cell,
the first liquid crystal cell including a first liquid crystal layer containing first liquid crystal molecules, and a first electrode pair which applies voltage to the first liquid crystal layer,
the second liquid crystal cell including a second liquid crystal layer containing second liquid crystal molecules, and a second electrode pair which applies voltage to the second liquid crystal layer,
with no voltage applied to the first liquid crystal layer and the second liquid crystal layer, an alignment direction of the first liquid crystal molecules near the second liquid crystal cell in the first liquid crystal layer is parallel to an alignment direction of the second liquid crystal molecules near the first liquid crystal cell in the second liquid crystal layer in a plan view.

2. The optical element according to claim 1,
wherein with no voltage applied to the first liquid crystal layer and the second liquid crystal layer, the alignment direction of the first liquid crystal molecules near the second liquid crystal cell in the first liquid crystal layer is parallel to the alignment direction of the second liquid crystal molecules near the first liquid crystal cell in the second liquid crystal layer in a cross-sectional view.

3. The optical element according to claim 1, wherein a thickness of the first liquid crystal layer is different from a thickness of the second liquid crystal layer.

4. The optical element according to claim 1, wherein a thickness D1 as a thickness of the first liquid crystal layer or a thickness of the second liquid crystal layer satisfies the following formula (1):
0.80×D≤D1<0.98×D (Formula 1)
where D represents an average thickness of the thickness of the first liquid crystal layer and the thickness of the second liquid crystal layer.

5. The optical element according to claim 1,
wherein a retardation of the first liquid crystal cell with no voltage applied to the first liquid crystal layer is different from a retardation of the second liquid crystal cell with no voltage applied to the second liquid crystal layer.

6. A three-dimensional display device comprising:
the optical element according to claim 1; and
a display panel on or behind a back surface side of the optical element.

7. The three-dimensional display device according to claim 6, further comprising a viewing angle compensation film.
